(19) United States
(12) Patent Application Publication
(10) Pub. No.: US 2024/0372849 A1
(43) Pub. Date: Nov. 7, 2024

(54) CERTIFICATE ISSUANCE SUPPORT SYSTEM, CERTIFICATE ISSUANCE SUPPORT METHOD AND PROGRAM

(71) Applicant: NIPPON TELEGRAPH AND TELEPHONE CORPORATION, Tokyo (JP)

(72) Inventors: Ryohei SUZUKI, Tokyo (JP); Koji CHIDA, Tokyo (JP); Tetsuya OKUDA, Tokyo (JP)

(21) Appl. No.: 18/565,755

(22) PCT Filed: Jun. 7, 2021
(86) PCT No.: PCT/JP2021/021568

§ 371 Date: Nov. 30, 2023

(51) Int. Cl. H04L 9/40

(52) U.S. Cl. CPC H04L 63/0823

(57) ABSTRACT

A certificate issuing support system includes: a certificate application device in a first organization making an application for issuing an EV certificate to a certificate authority; and an existence guarantee device included in a second organization that guarantees existence of the first organization. The existence guarantee device assigns a first electronic signature to first information guaranteeing existence of the first organization in response to a request from a terminal used by a member of the first organization, and verifies a second electronic signature assigned to second information that is generated by the certificate application device and guarantees affiliation of the member to the first organization in cooperation with the certificate authority. The certificate application device assigns a third electronic signature to third information indicating an authority of a person who approves the application for issuing the EV certificate, and transmits the first information to which the first electronic signature is assigned, the second information to which the second electronic signature is assigned, and the third information to which the third electronic signature is assigned to the certificate authority in order to obtain the approval of the issuing of the EV certificate, and thus automatic issuing of the EV certificate is supported.

### TECHNICAL FIELD

The present invention relates to a certificate issuing support system, a certificate issuing support method, and a program.

### BACKGROUND ART

An electronic certificate indicating the identity of a website is an electronic certification of identity from a trusted third party. An electronic certificate includes a domain validation (DV) certificate, an organization validation (OV) certificate, and an extended validation (EV) certificate depending on the degree of identity confirmation. A DV certificate is a certificate issued after possession of a domain by an applicant is confirmed. An OV certificate refers to a certificate issued by confirming the existence of a certificate application organization and whether an applicant belongs to the organization in addition to possession of a domain by the applicant. An EV certificate is a certificate issued by confirming whether an issuing application has been approved by an authorized person in the organization in addition to the confirmation necessary for an OV certificate.

Automatic certificate management environment (ACME) is known as a protocol used to issue a DV certificate (see Non Patent Literature 1). By using the ACME, it is possible to automatically issue a DV certificate.

On the other hand, electronic know your customer (eKYC) is known as a technique for electronically guaranteeing the identity of an individual (Non Patent Literature 2).

### CITATION LIST

### Non Patent Literature

Non Patent Literature 1: Automatic Certificate Management Environment (RFC8555), [online], Internet <URL: https://tools.ietf.org/html/rfc8555>
Non Patent Literature 2: Koichi Miyagawa, “eKYC as means of identity confirmation and future development”, JNSA Press No. 48, pp. 2-8, 2020/1, [online], Internet <URL: https://www.jnsa.org/jnsapress/vol48/2_kikou.pdf>

### SUMMARY OF INVENTION

### Technical Problem

However, since whether the confirmation of existence of an organization or a certificate issuing application has been approved by an authorized person in the organization is not considered, ACME cannot be applied to EV certificate issuing as it is. In the related art, in issuing of an EV certificate, to which organization a certificate is to be issued, whether an applicant belongs to the organization, and whether a certificate issuing application has been approved by an authorized person in the organization have been manually checked with a document or by telephone.

Further, in order to confirm that an issuing application has also been approved by the authorized in the organization, it is necessary to guarantee that a person who has approved the issuing application is an authorized person. However, in the ekYC, information (an affiliation department and a management position) regarding members in the organization cannot be guaranteed to the outside.

Accordingly, in the technology of the related art, it is difficult to automatically issue an EV certificate.

The present invention has been made in view of the foregoing circumstances and an object of the prevent invention is to support automatic issuing of an EV certificate.

### Solution to Problem

Accordingly, in order to solve the foregoing problems, a certificate issuing support system includes: a certificate application device in a first organization making an application for issuing an EV certificate to a certificate authority; and an existence guarantee device included in a second organization that guarantees existence of the first organization. The existence guarantee device includes a first assignment unit that assigns a first electronic signature to first information guaranteeing existence of the first organization in response to a request from a terminal used by a member of the first organization, and a verifying unit that verifies a second electronic signature assigned to second information that is generated by the certificate application device and guarantees affiliation of the member to the first organization in cooperation with the certificate authority. The certificate application device includes a second assignment unit that assigns a third electronic signature to third information indicating an authority of a person who approves the application for issuing the EV certificate, and a transmission unit that transmits the first information to which the first electronic signature is assigned, the second information to which the second electronic signature is assigned, and the third information to which the third electronic signature is assigned to the certificate authority in order to obtain the approval of the issuing of the EV certificate.

### Advantageous Effects of Invention

It is possible to support automatic issuing of an EV certificate.

### BRIEF DESCRIPTION OF DRAWINGS

FIG. 1 is a diagram illustrating an exemplary configuration of a certificate issuing support system according to a first embodiment.

FIG. 2 is a diagram illustrating an exemplary hardware configuration of an existence guarantee device 10 according to the first embodiment.

FIG. 3 is a diagram illustrating an exemplary functional configuration of the certificate issuing support system according to the first embodiment.

FIG. 4 is a sequence diagram illustrating an example of a processing procedure executed in the certificate issuing support system.

FIG. 5 is a sequence diagram illustrating an example of a processing procedure of a process of confirming existence of a corporation according to the first embodiment.

FIG. 6 is a sequence diagram illustrating an example of a processing procedure of a process of confirming affiliation of a person in charge to a corporation.

FIG. 7 is a sequence diagram illustrating an example of a processing procedure of a confirmation process of confirming that a certificate issuing application has been approved by an authorized person.

FIG. 8 is a diagram illustrating an exemplary functional configuration of a certificate issuing support system according to a second embodiment.

FIG. 9 is a sequence diagram illustrating an example of a processing procedure of a process of confirming existence of a corporation according to the second embodiment.

### DESCRIPTION OF EMBODIMENTS

The present embodiment discloses an electronic issuing procedure of an EV certificate including not only an existing domain possession confirmation but also a flow of confirming an “existence of an application organization”, “affiliation of an applicant to the organization”, and an “approval by an authorized person” by extending an automatic certificate management environment (ACME). The authority is an authority (for example, a certain position) in an organization. An extended validation (EV) certificate is an electronic certificate issued after confirming whether there is an organization to which a certificate is issued, whether an applicant belongs to the organization to which the certificate is issued, and whether an issuing application is also approved by an authorized person in the organization, in addition to the fact that the applicant owns a domain when the certificate is issued.

In order to enable an electronic process for such confirmation, an ekYC method of guaranteeing that a member belongs to an organization is disclosed.

In the present embodiment, a specific organization that makes application for issuing of an EV certificate is referred to as a “corporation”. A member of an organization (corporation) is referred to as a “member”. A specific person who is an applicant for issuing a certificate among members is referred to as a “person in charge”. A member who approves of application for issuing a certificate by a person in charge is referred to as a “manager”. A corporation assigns attribute information such as a position to each member. The manager is, for example, a member of a certain position or higher (for example, a section chief or higher, or the like) to whom attribute information is assigned. The manager may be or may not be a direct manager of the person in charge.

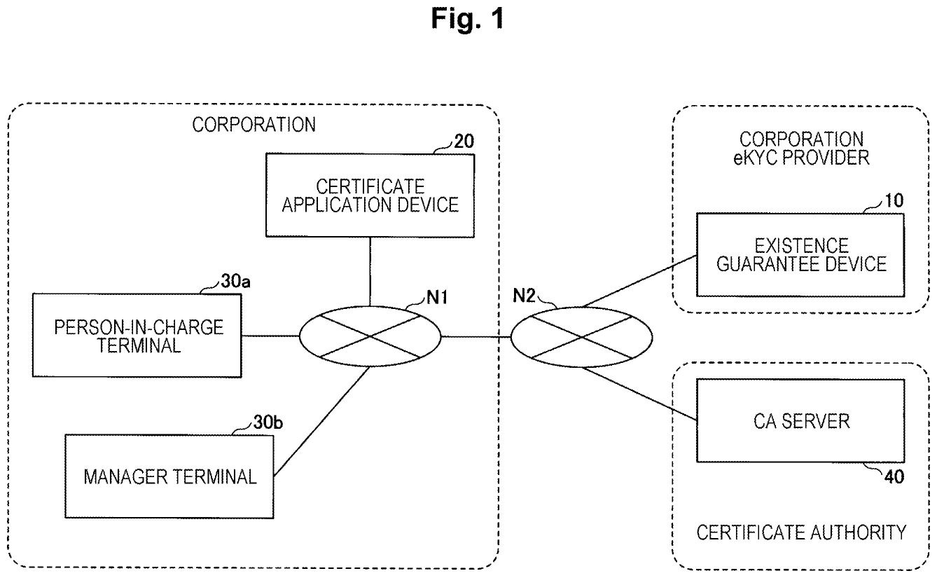

Hereinafter, embodiments of the present invention will be described with reference to the drawings. FIG. 1 is a diagram illustrating an exemplary configuration of a certificate issuing support system according to a first embodiment. In FIG. 1, each region surrounded by a dotted line indicates an organization. In the present embodiment, computers of three organizations of a corporation, a corporation ekYC provider, and a certificate authority cooperate with each other via a network.

The corporation is an example of an organization to which an EV certificate is issued (an issuing application source). The corporation is in a state in which a member can be authenticated. For example, a corporation may issue an ID/PW or the like to each member to authenticate a member within the corporation. In FIG. 1, a corporation includes a certificate application device 20, one or more person-in-charge terminals 30a, and one or more manager terminals 30b.

The person-in-charge terminal 30a is a terminal such as a personal computer (PC) used by a person in charge who is a member in charge of certificate issuing application work. The person-in-charge terminal 30a is connected to the certificate application device 20 and the manager terminal 30b via a corporation network N1 and is connected to the existence guarantee device 10 and the CA server 40 via the network N1 and a network N2 such as the Internet.

The manager terminal 30b is a terminal such as a PC used by the manager. The manager terminal 30b is connected to the certificate application device 20 and the person-in-charge terminal 30a via the network N1 in the corporation.

The certificate application device 20 authenticates a member, and functions as an extended ACME client when the member has an authority (hereinafter simply referred to as “authority”.) to make request for information that guarantees existence of a corporation from the corporation ekYC provider (hereinafter referred to as “existence guarantee information”). The certificate application device 20 functions as an extended ACME client to cause the existence guarantee device 10 to guarantee existence of a corporation and guarantee the existence of a member to the existence guarantee device 10. The certificate application device 20 further guarantees that a certificate issuing application is also approved by an authorized person (a manager in the present embodiment). The existence of the member means that the member surely belongs to the corporation. The certificate application device 20 is connected to the existence guarantee device 10 and the CA server 40 via the network N1 and the network N2.

The corporation ekYC provider is an organization of which existence is assumed in the present embodiment, and is an organization that guarantees the existence of a corporation (representation of a corporation). The corporation ekYC provider has a function as a general PKI authentication infrastructure (hereinafter referred to as “corporation PKI”), and a corporation PKI allows a corporation to utilize an electronic signature. Since the corporation ekYC provider is also a PKI authentication infrastructure, the corporation ekYC provider also functions as a certificate authority (CA) of a public key certificate for authentication. The certificate authority is a CA (CA that issues an EV certificate) for guaranteeing a corporation web server and the corporation ekYC provider functions as a CA as an authentication infrastructure. That is, the roles of the certificate authority and the corporation ekYC provider are different.

The corporation ekYC provider may be implemented by an administration or a third-party organization. That is, the government or the like may electronically guarantee the existence of a corporation, or there may be a third-party organization that provides information for confirming identification of the corporation. In any case, since the identity of the corporation can be guaranteed, the guarantor of the identity (existence or identification) of the corporation may be either administrative or third party.

In FIG. 1, the corporation ekYC provider includes the existence guarantee device 10. The existence guarantee device 10 is one or more computers that electronically implement functions of the corporation ekYC provider. For example, a provider server confirms the guarantee of existence of a corporation and the existence of a member (affiliation of the member to the corporation).

The certificate authority is an existing certificate authority. In FIG. 1, the certificate authority includes the CA server 40. In the present embodiment, the CA server 40 issues an extended validation (EV) certificate to a corporation according to the ACME.

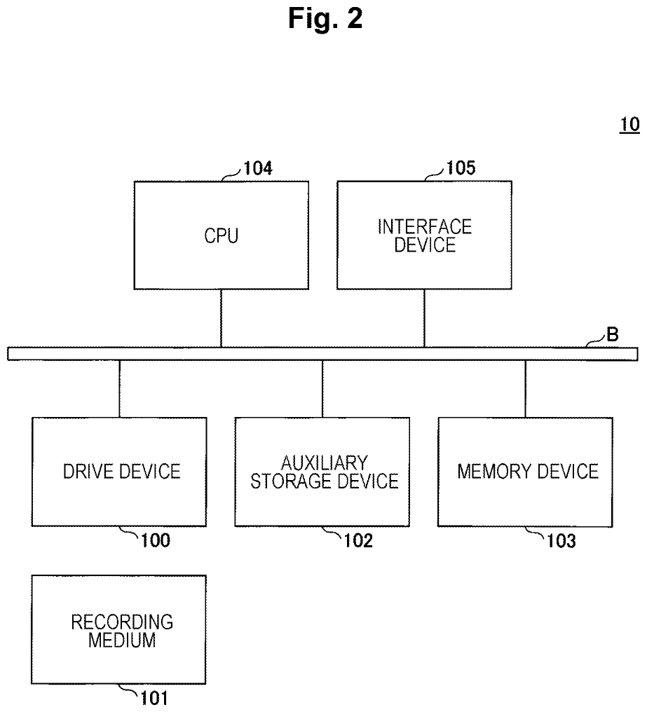

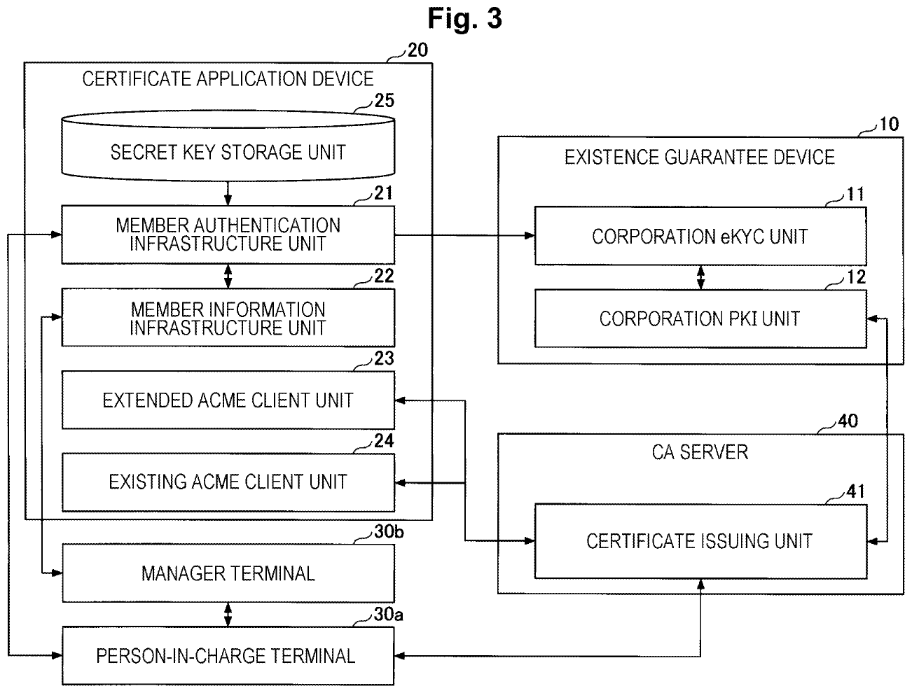

FIG. 2 is a diagram illustrating an exemplary hardware configuration of the existence guarantee device 10 in the first embodiment. The existence guarantee device 10 in FIG. 3 includes a drive device 100, an auxiliary storage device 102, a memory device 103, a CPU 104, an interface device 105 which are connected to each other via a bus B.

A program implementing a process in the existence guarantee device 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores necessary files, data, and the like.

When an instruction to start the program is received, the memory device 103 reads and stores the program from the auxiliary storage device 102. The CPU 104 executes a function related to the existence guarantee device 10 in accordance with a program stored in the memory device 103. The interface device 105 is used as an interface connecting to a network.

FIG. 3 is a diagram illustrating an exemplary functional configuration of the certificate issuing support system according to the first embodiment. In FIG. 3, the certificate application device 20 includes a member authentication infrastructure unit 21, a member information infrastructure unit 22, an extended ACME client unit 23, and an existing ACME client unit 24. These units are implemented through a process of causing a CPU of the certificate application device 20 to execute one or more programs installed in the certificate application device 20. However, these units may be implemented by different computers. The certificate application device 20 also uses a secret key storage unit 25. The secret key storage unit 25 can be implemented by using, for example, an auxiliary storage device of the certificate application device 20, a storage device connectable to the certificate application device 20 via a network, or the like.

The member authentication infrastructure unit 21 authenticates a member and confirms presence or absence of authority of the member.

The member information infrastructure unit 22 manages attribute information (information indicating a position or the like) of the member.

The extended ACME client unit 23 and the existing ACME client unit 24 are ACME clients in the present embodiment. The ACME client is software that interprets exchange based on the ACME with the CA server 40 supporting an automatic certificate management environment (ACME) which is a certificate automatic issuing protocol, and executes certificate issuing application and the like.

The extended ACME client unit 23 executes a flow extended with respect to an ACME protocol in the present embodiment.

The existing ACME client unit 24 interacts with the CA server 40 in an existing ACME protocol.

The secret key storage unit 25 stores a secret key (hereinafter referred to as a “corporation secret key”) used for assigning a signature which can be verified by the corporation PKI unit 12 of the existence guarantee device 10. The corporation secret key is provided from the corporation PKI unit 12.

The existence guarantee device 10 includes a corporation ekYC unit 11 and a corporation PKI unit 12. These units are implemented through a process of causing the CPU 104 to execute one or more programs installed in the existence guarantee device 10. However, these units may be implemented by different computers.

The corporation ekYC unit 11 provides the corporation with information (existence guarantee information) that guarantees existence of the corporation. The corporation ekYC unit 11 causes the corporation PKI unit 12 to assign an electronic signature by the corporation ekYC provider to the information guaranteeing the existence of the corporation.

The corporation PKI unit 12 provides a general PKI for a corporation. For example, the corporation PKI unit 12 distributes a public key certificate and a root certificate of the corporation ekYC provider to the corporation.

The CA server 40 includes a certificate issuing unit 41. The certificate issuing unit 41 is implemented through a process of causing the CPU of the CA server 40 to execute one or more programs installed in the CA server 40.

The certificate issuing unit 41 issues an electronic certificate (in the present exemplary embodiment, an EV certificate) based on the ACME which is an automatic certificate issuing protocol.

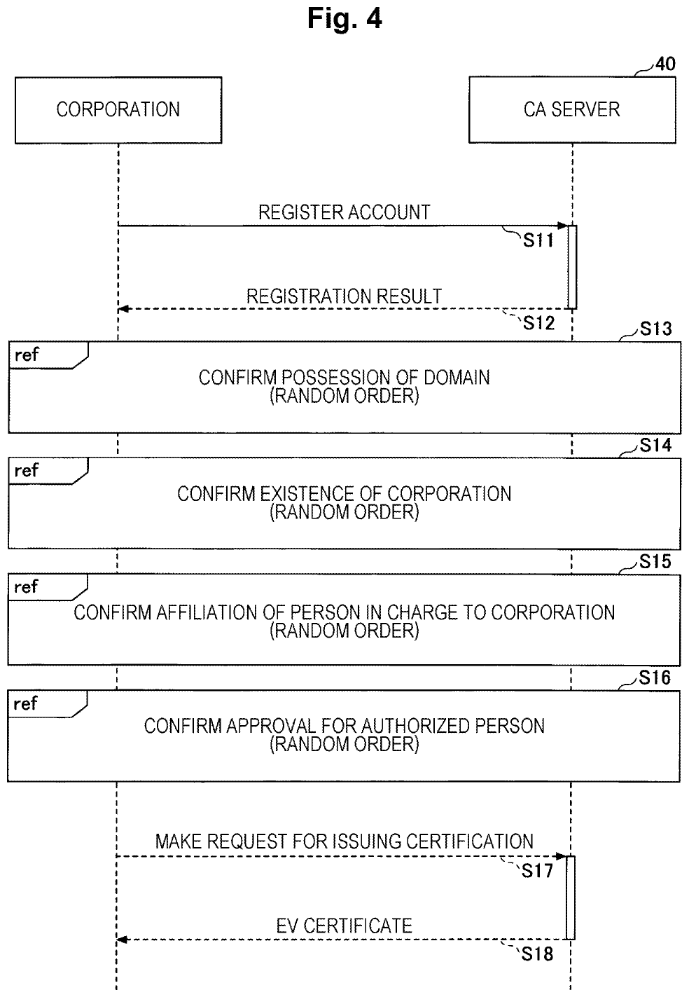

Hereinafter, a processing procedure executed in the certificate issuing support system will be described. FIG. 4 is a sequence diagram illustrating an example of a processing procedure executed in the certificate issuing support system. In FIG. 4, the axis of “corporation” represents a set of the person-in-charge terminal 30a, the manager terminals 30b and 30b, the existing ACME client unit 24, the extended ACME client unit 23, and the member authentication infrastructure unit 21. In FIG. 4, steps S11 to S13, S17, and S18 are steps based on the existing ACME. Accordingly, the extended ACME client unit 23 is not involved in these steps. On the other hand, steps S14 to S16 are steps of extension to the ACME. Accordingly, the existing ACME client unit 24 is not involved in steps S14 to S16.

In step S11, the corporation registers an account for the corporation with the CA server 40. The CA server 40 responds with a registration result of the account (S12). In registration of an account, a public key of the corporation (a public key corresponding to the corporation private key (hereinafter referred to as a “corporation public key”)) is also registered in the CA server 40. In this way, the CA server 40 is enabled to authenticate the corporation in subsequent steps. That is, in the subsequent steps, as in the existing ACME, the CA server 40 authenticates the corporation for each request from the corporation to the CA server 40. The registration of the account may be executed once.

An execution order of the subsequent steps S13 to S16 is a random order, and these steps may be executed asynchronously (at any timing).

In step S13, a process of confirming that the corporation possesses a domain (a domain related to certificate application) is executed between the corporation and the CA server 40 according to the ACME.

In step S14, a process of confirming existence of the corporation is executed in cooperation with the corporation, the CA server 40, and the existence guarantee device 10.

In step S15, the process of confirming the affiliation of the person in charge to the corporation (existence of the person in charge) is executed in cooperation with the corporation, the CA server 40, and the existence guarantee device 10.

In step S16, a process of also confirming approval of application for issuing a certification by an authorized person is executed in cooperation between the corporation and the CA server 40.

Whenever steps S13 to S16 are executed, the CA server 40 records information indicating what confirmation has been completed for the corporation in association with the account of the corporation. That is, when step S13 is normally completed, the CA server 40 records information indicating that confirmation of the possession of the domain by the corporation has been completed. When step S14 is normally completed, the CA server 40 records information indicating that the confirmation of existence of the corporation has been completed. When step S15 is normally completed, the CA server 40 records information indicating that the confirmation of affiliation of the person in charge to the corporation has been completed. When step S16 is normally completed, the CA server 40 records information indicating that confirmation that the certificate issuing application has been approved by an authorized person has been completed. Since the authentication of the corporation is executed in each of steps S13 to S16, the CA server 40 can identify which corporation has been confirmed.

At any timing after the execution of steps S13 to S16, the corporation (for example, the existing ACME client unit 24) transmits a certificate signing request (CSR) to the CA server 40 (S17). In the certificate signing request, the CA server 40 authenticates the corporation.

In response to the certificate signing request, the CA server 40 confirms which confirmation of steps S13 to S16 has been completed for a corporation that is a transmission source of the certificate signing request (a corporation authenticated with respect to the certificate signing request). When the confirmation is all completed, the CA server 40 generates an EV certificate for the corporation and responds with the EV certificate to the corporation (S18).

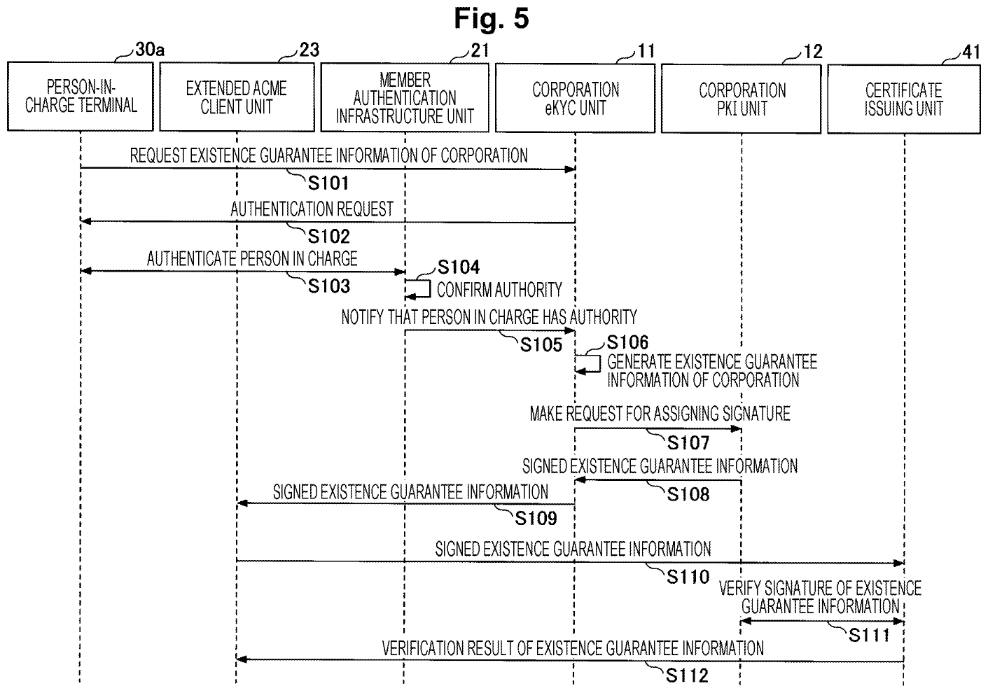

Next, details of step S14 will be described. FIG. 5 is a sequence diagram illustrating an example of a processing procedure of a process of confirming existence of the corporation according to the first embodiment.

In step S101, the person-in-charge terminal 30a requests the existence guarantee information of the corporation from the corporation ekYC unit 11 in response to an input by the person in charge (an instruction to acquire the existence guarantee information of the corporation). The corporation ekYC unit 11 transmits an authentication request to the person-in-charge terminal 30a in response to the request from the person-in-charge terminal 30a (S102). The reason why the authentication request is transmitted from the corporation ekYC unit 11 to the person-in-charge terminal 30a is that the member authentication infrastructure unit 21 capable of authenticating a member is located in the corporation (in the certificate application device 20), and the existence guarantee device 10 cannot authenticate the member. Accordingly, the corporation ekYC unit 11 transmits the authentication request to the person-in-charge terminal 30a so that the authentication request is redirected to the member authentication infrastructure unit 21.

In response to the authentication request, the person-in-charge terminal 30a cooperates with the member authentication infrastructure unit 21 of the certificate application device 20 to authenticate the person in charge (S103). For example, the person-in-charge terminal 30a displays a screen for inputting an ID and a password of the person in charge for the authentication. The person-in-charge terminal 30a transmits the ID and the password input on the screen to the member authentication infrastructure unit 21. The member authentication infrastructure unit 21 compares the ID and the password with a correct ID and a password stored in advance in the certificate application device 20. When both the IDs and the passwords match each other, the person in charge is successfully authenticated. The authentication is authentication for acquiring existence guarantee information of the corporation (that is, in order to use the corporation ekYC unit 11).

When the person in charge has been successfully authenticated, the member authentication infrastructure unit 21 confirms whether the person in charge has authority to “request the corporation ekYC unit 11 for the existence guarantee information of the corporation” (S104). For example, information indicating presence or absence of the authority is stored in the certificate application device 20 for each member of the corporation, and the member authentication infrastructure unit 21 confirms whether the person in charge has the authority with reference to the information.

When the person in charge has authority, the member authentication infrastructure unit 21 notifies the corporation ekYC unit 11 that the person in charge has the authority (S105). Such notification may be executed in any procedure. For example, the corporation ekYC unit 11 may transmit a token which is data indicating that the person in charge has the authority to the person-in-charge terminal 30a, and then the person-in-charge terminal 30a may transmit the token to the corporation ekYC unit 11. In this case, when the corporation ekYC unit 11 inquires of the member authentication infrastructure unit 21 about presence or absence of the authority accompanied by the token, the member authentication infrastructure unit 21 may verify the token. When the token is valid, the member authentication infrastructure unit 21 may respond to the corporation ekYC unit 11 with the notification indicating that there is the authority.

In response to the notification indicating that the person in charge has the authority, the corporation eKYC unit 11 generates the existence guarantee information of the corporation (S106). For example, the corporation eKYC unit 11 generates the following existence guarantee information in a JavaScript (registered trademark) object notation (JSON) format.
{“iss”:“https://ekyc.example.com”,“aud”:“xxxx”,“name”:“xxxx Corp”, . . . }

In the existence guarantee information, “xxxx” is, for example, a character string indicating a name of the corporation.

Subsequently, the corporation ekYC unit 11 transmits the existence guarantee information to the corporation PKI unit 12, and requests the corporation PKI unit 12 to assign a signature (electronic signature) for the existence guarantee information (S107). By using the corporation PKI, the corporation PKI unit 12 signs the existence guarantee information with the secret key of the corporation ekYC provider (assigns a signature to the existence guarantee information) and returns the signed existence guarantee information to the corporation ekYC unit 11 (S108). With the signature, the CA server 40 can confirm authenticity of the existence guarantee information.

Subsequently, the corporation ekYC unit 11 transmits the signed existence guarantee information to the extended ACME client unit 23 of the certificate application device 20 (S109). However, the existence guarantee information may be transmitted to the extended ACME client unit 23 via the person-in-charge terminal 30a. In this case, the corporation ekYC unit 11 transmits the existence guarantee information to the person-in-charge terminal 30a as a response to step S101. The person-in-charge terminal 30a transmits the existence guarantee information to the extended ACME client unit 23.

Subsequently, the extended ACME client unit 23 transmits the existence guarantee information to the certificate issuing unit 41 of the CA server 40 (S110). When the existence guarantee information is received, the certificate issuing unit 41 causes the corporation PKI unit 12 to verify the signature assigned to the existence guarantee information (S111). When the corporation PKI unit 12 confirms that the signature is correct, the certificate issuing unit 41 transmits a verification result of the existence guarantee information to the extended ACME client unit 23 (S112). The certificate issuing unit 41 records the existence guarantee information in the CA server 40 as information indicating that the confirmation of the existence of the corporation has been completed.

In FIG. 4, the existence guarantee information is transmitted to the certificate issuing unit 41 by the extended ACME client unit 23, but any procedure may be adopted when the existence guarantee information finally reaches the certificate issuing unit 41. The CA and the corporation ekYC provider may directly cooperate to obtain information. At that time, a technology based on OAuth 2.0 may be used.

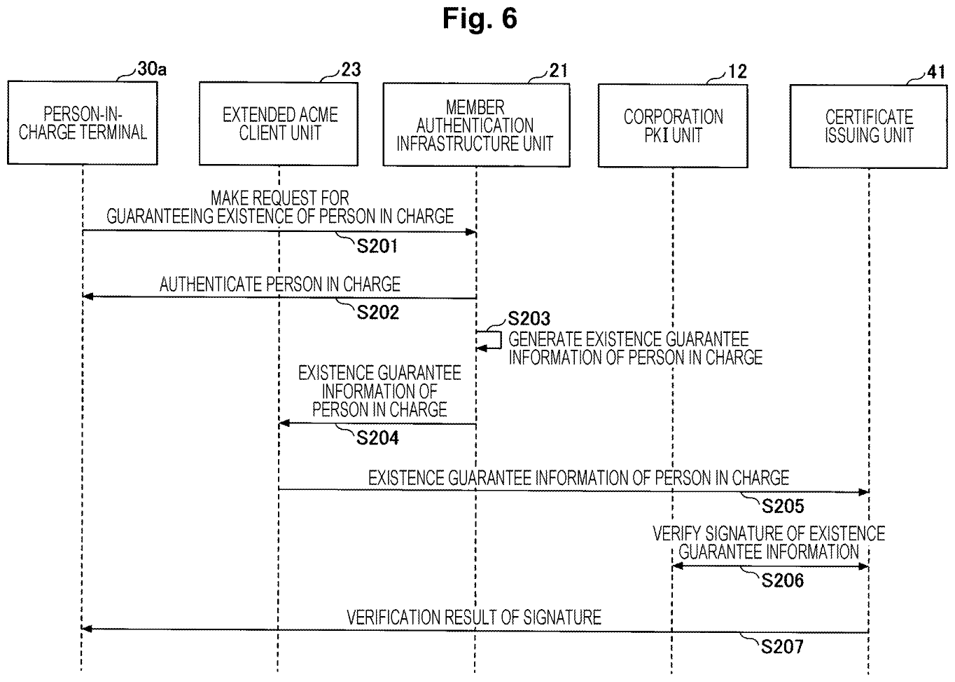

Next, details of step S15 in FIG. 4 will be described. FIG. 6 is a sequence diagram illustrating an example of a processing procedure of a process of confirming affiliation of a person in charge to a corporation.

In step S201, the person-in-charge terminal 30a requests the member authentication infrastructure unit 21 to guarantee the existence of the person in charge in response to an input by the person in charge (an instruction to request the existence guarantee of the person in charge). The member authentication infrastructure unit 21 executes authentication of the person in charge in cooperation with the person-in-charge terminal 30a (S202). Through the authentication, it is confirmed whether the person in charge is the person in charge.

When the person in charge has been successfully authenticated, the member authentication infrastructure unit 21 generates the existence guarantee information of the person in charge (S203). For example, the member authentication infrastructure unit 21 generates the following existence guarantee information in the JSON format.
{“affiliation”:“xxx Corp.”,“name”:“yyy”, . . . }

In the existence guarantee information, for example, “xxx” is a character string indicating the name of the corporation, and “yyy” is a character string indicating the name of the person in charge.

The member authentication infrastructure unit 21 signs (assigns a signature) the generated existence guarantee information using the corporation secret key. By assigning a signature to the existence guarantee information using the corporation secret key, the existence (affiliation) of the person in charge is guaranteed by the corporation. The certificate issuing unit 41 can confirm authenticity of the existence guarantee information with the signature. The signature may be executed by an external service. For example, a management function or a signature function of the corporation secret key may be executed by an external service.

Subsequently, the member authentication infrastructure unit 21 transmits the signed existence guarantee information to the extended ACME client unit 23 (S204). However, the existence guarantee information may be transmitted to the extended ACME client unit 23 via the person-in-charge terminal 30a. In this case, the member authentication infrastructure unit 21 transmits the existence guarantee information to the person-in-charge terminal 30a as a response to step S201. The person-in-charge terminal 30a transmits the existence guarantee information to the extended ACME client unit 23.

Subsequently, the extended ACME client unit 23 transmits the existence guarantee information to the certificate issuing unit 41 of the CA server 40 (S205). When the existence guarantee information is received, the certificate issuing unit 41 verifies the signature assigned to the existence guarantee information in cooperation with the corporation PKI unit 12 (S206). In other words, the corporation PKI unit 12 verifies the signature assigned to the existence guarantee information in cooperation with the certificate issuing unit 41. For example, the certificate issuing unit 41 to which a corporation public key is distributed from the corporation PKI unit 12 verifies the signature. However, the corporation public key may be distributed in accordance with another method (another timing). Alternatively, the corporation PKI unit 12 may verify the signature assigned to the existence guarantee information and transmit the result to the certificate issuing unit 41.

When it is confirmed that the signature is correct, the certificate issuing unit 41 transmits a verification result of the signature to the person-in-charge terminal 30a (S207). The certificate issuing unit 41 records the existence guarantee information in the CA server 40 as information indicating that the confirmation of the affiliation of the person in charge to the corporation has been completed.

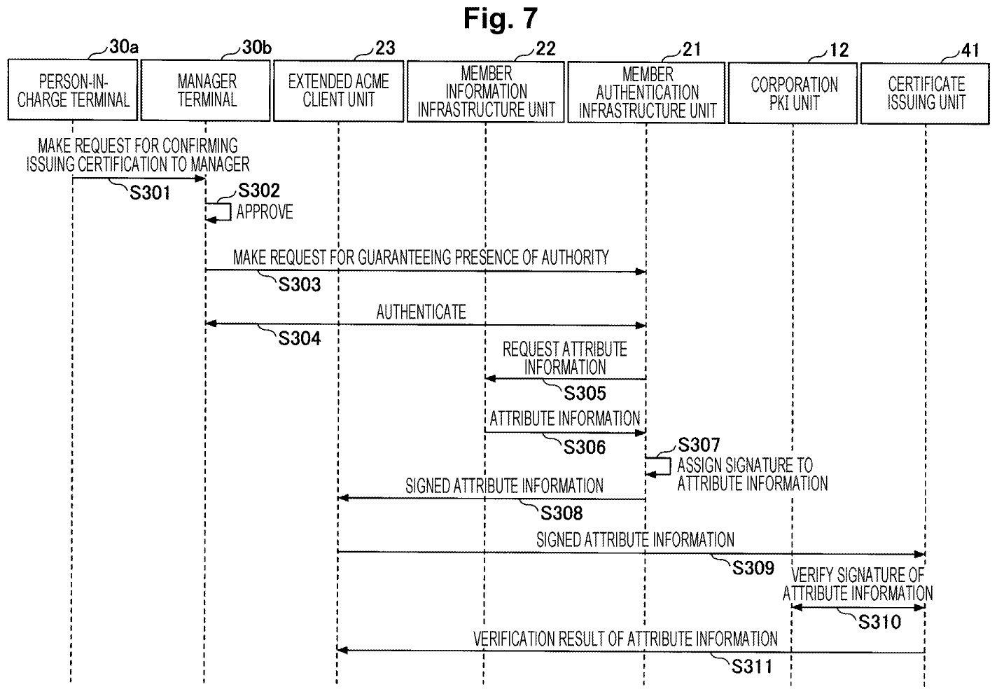

Next, details of step S16 in FIG. 4 will be described. FIG. 7 is a sequence diagram illustrating an example of a processing procedure of a confirmation process of confirming that a certificate issuing application has been approved by an authorized person.

In step S301, the person-in-charge terminal 30a transmits an approval request for the certificate issuing application to the manager terminal 30b in response to the input by the person in charge (instruction for requesting approval regarding the certificate issuing application). The manager terminal 30b notifies the manager by displaying the approval request or the like. The manager confirms the issuing application related to the approval request, and inputs an indication of an approval to the manager terminal 30b when the approval can be made (S302).

In response to the input of the approval, the manager terminal 30b requests the member authentication infrastructure unit 21 to guarantee that the manager has an authority. The member authentication infrastructure unit 21 executes the authentication of the manager in cooperation with the manager terminal 30b (S304). Through the authentication, it is confirmed whether the manager is the person in question. The authentication method may be similar to the case of the person in charge.

When the manager has been successfully authenticated, the member authentication infrastructure unit 21 requests attribute information indicating the authority of the manager from the member information infrastructure unit 22 (S305). At this time, the member information infrastructure unit 22 is notified of the ID of the manager. The member information infrastructure unit 22 transmits a response including attribute information (that is, the attribute information of the manager) corresponding to the ID to the member authentication infrastructure unit 21 (S306). The attribute information of each member is stored, for example, in the auxiliary storage device 102 or the like in association with the ID of each member. The attribute information is, for example, information including a position, a department, and the like of the manager in the following format.
{“Position”:“Manager”,“Department”;“yyy”, . . . }

Subsequently, the member authentication infrastructure unit 21 signs the attribute information (assigns a signature) using the corporation secret key (S307). By assigning the signature to the existence guarantee information using the corporation secret key, the attribute information is guaranteed by the corporation.

Subsequently, the member authentication infrastructure unit 21 transmits the signed attribute information to the extended ACME client unit 23 (S308). Here, the attribute information may be transmitted to the extended ACME client unit 23 via the manager terminal 30b and the person-in-charge terminal 30a. In this case, the member authentication infrastructure unit 21 transmits the attribute information to the manager terminal 30b as a response to step S303. As a response to step S301, the manager terminal 30b transmits the attribute information to the person-in-charge terminal 30a. The person-in-charge terminal 30a transmits the attribute information to the extended ACME client unit 23.

Subsequently, the extended ACME client unit 23 transmits the attribute information to the certificate issuing unit 41 of the CA server 40 (S309). When the attribute information is received, the certificate issuing unit 41 verifies the signature assigned to the attribute information in cooperation with the corporation PKI unit 12 (S310). In other words, the corporation PKI unit 12 verifies the signature assigned to the attribute information in cooperation with the certificate issuing unit 41. For example, the certificate issuing unit 41 to which a corporation public key is distributed from the corporation PKI unit 12 verifies the signature. However, the corporation public key may be distributed in accordance with another method (another timing). Alternatively, the corporation PKI unit 12 may verify the signature assigned to the attribute information and transmit the result to the certificate issuing unit 41.

When it is confirmed that the signature is correct, the certificate issuing unit 41 records the attribute information in the CA server 40 as information indicating that confirmation of an approval of the certificate issuing application also by an authorized person has been completed.

In order to clarify that the attribute information has been confirmed each time (to prevent replay), the certificate issuing unit 41 may issue a challenge token, and the member authentication infrastructure unit 21 may also sign the attribute information including the challenge token.

When the manager is a director or the like, it is possible to confirm that an authorized person is also approved in a procedure different from the sequence of FIG. 7. In FIG. 7, the attribute information is guaranteed using the corporation secret key in order to present the authenticity of the information (a position or the like) in the corporation to the outside. On the other hand, in the case of a director, since information is disclosed by commercial registration, the “position” can be objectively confirmed. Therefore, it is sufficient that evidence such as a (individual) signature approved by the director can be verified. In this case, the signature may be generated with a private key issued to an individual by a public organization (for example, a secret key in my number card is used.).

As described above, according to the first embodiment, by extending the ACME, it is possible to electronically confirm the existence of a corporation and to implement eKYC (electronic identity confirmation (of an individual)) that guarantees affiliation of a person in charge (applicant) to a corporation. Further, it can be guaranteed that the certificate issuing application is also approved by an authorized person in a corporation (in an organization). As a result, the application for the EV certificate can be executed all electronically, and thus the automatic issuing of the EV certificate can be supported.

Although FIG. 7 illustrates a processing procedure specialized for certificate issuing, “confirmation of attribute information assigned in an organization” itself can be used as ekYC of a member in other use cases. For example, when a securities account is opened, an office or a position is registered in order to prevent insider trading. At present, since information is input in person, the information is not necessarily correct in some cases. A usage method of executing ekYC of a member at the time of opening an account, and providing correct information guaranteed by the company to a securities company is conceivable. Next, a second embodiment will be described. In the second embodiment, differences from the first embodiment will be described. Points not specifically mentioned in the second embodiment may be the same as those in the first embodiment.

In the second embodiment, a modification of the processing procedure (that is, the processing procedure of FIG. 5) of step S14 in FIG. 4 will be described.

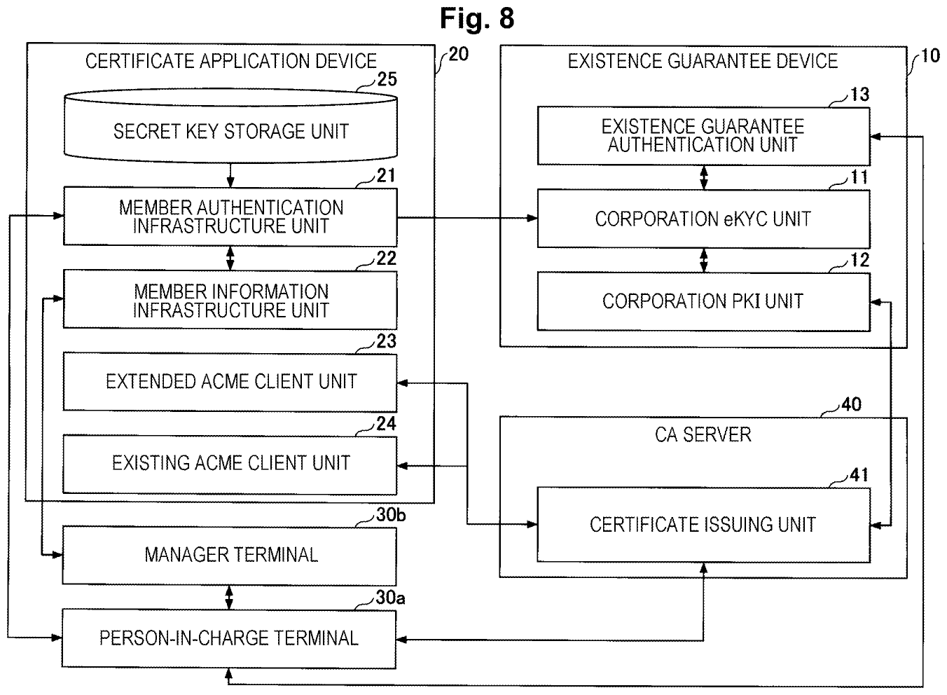

FIG. 8 is a diagram illustrating an exemplary functional configuration of a certificate issuing support system according to the second embodiment. In FIG. 8, the existence guarantee device 10 further includes an existence guarantee authentication unit 13. The existence guarantee authentication unit 13 is implemented through a process of causing the CPU 104 to execute one or more programs installed in the existence guarantee device 10.

The existence guarantee authentication unit 13 authenticates a person in charge for existence guarantee of a corporation. In order to enable such authentication, according to the second embodiment, an account of a person in charge permitted to make a request for existence guarantee is registered in advance in the existence guarantee device 10. In registration of such an account, a system for cross-domains identity management (SCIM) may be used.

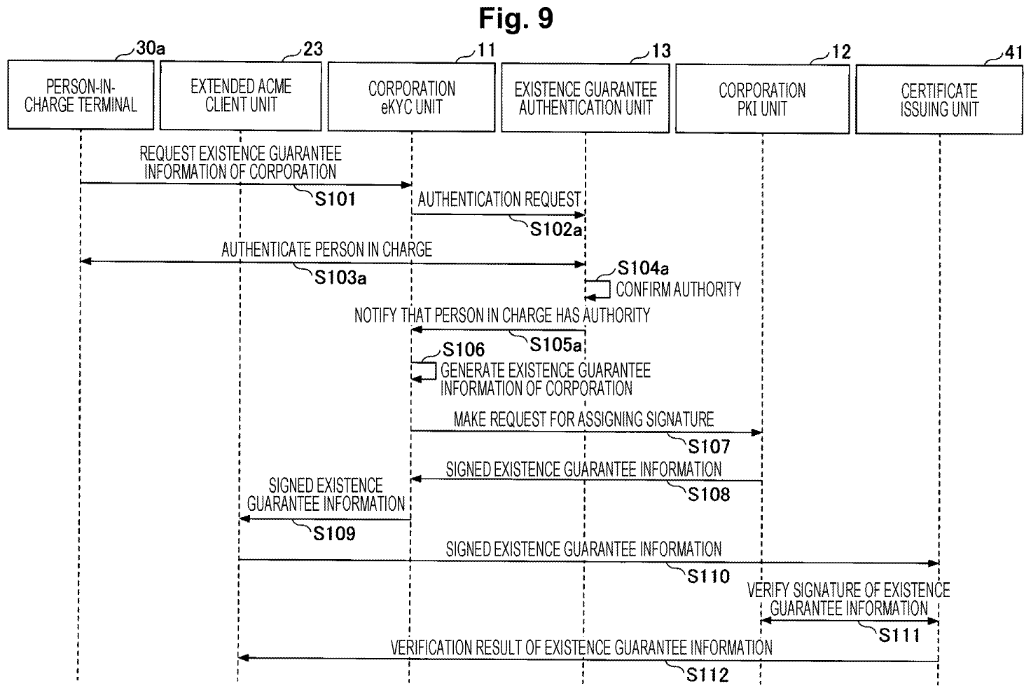

FIG. 9 is a sequence diagram illustrating an example of a processing procedure of a process of confirming existence of a corporation according to the second embodiment. In FIG. 9, the same steps as those in FIG. 5 are denoted by the same step numbers, and the description thereof will be omitted as appropriate.

In FIG. 9, steps S102 to S105 in FIG. 5 are replaced with steps S102a to S105a.

In step S102a, the corporation ekYC unit 11 requests the existence guarantee authentication unit 13 to authenticate the person in charge. In response to the authentication request, the existence guarantee authentication unit 13 cooperates with the person-in-charge terminal 30a to execute authentication of the person in charge (S103a). For example, the existence guarantee authentication unit 13 transmits, to the person-in-charge terminal 30a, a web page for displaying a screen on which the ID and password of the person in charge for the authentication are input. The person-in-charge terminal 30a displays the screen based on the web page. The person-in-charge terminal 30a transmits the ID and password input on the screen to the existence guarantee authentication unit 13. The existence guarantee authentication unit 13 compares the ID and the password with an account (correct ID and password) registered in advance. When the IDs and the passwords match each other, the authentication of the person in charge succeeds. The existence guarantee authentication unit 13 may authenticate the person in charge in cooperation with the member authentication infrastructure unit 21.

When the authentication of the person in charge succeeds, the existence guarantee authentication unit 13 confirms whether the person in charge has authority to “request the existence guarantee information of the corporation to the corporation ekYC unit 11” (S104a). For example, information indicating such an authorized person is stored in the existence guarantee device 10, and the existence guarantee authentication unit 13 confirms whether the person in charge has authority with reference to the information.

When the person in charge has the authority, the existence guarantee authentication unit 13 notifies the corporation ekYC unit 11 that the person in charge has the authority (S105a). The subsequent steps are similar to those in FIG. 5.

In the second embodiment, since there is the authentication function of the person in charge in the existence guarantee device 10, the existence guarantee device 10 can directly provide the authentication function to the person in charge. The notification indicating that the person in charge has the authority can be completed in the cooperation in the existence guarantee device 10.

In the case of the first embodiment, the existence guarantee device 10 does not need to know a member who is a request source (an applicant) of the existence guarantee (the corporation ekYC provider only knows that an authorized member has made the request, and does not know who is the members making the request.). On the other hand, according to the second embodiment, the corporation ekYC provider knows who is the applicant among the members.

In each of the above embodiments, the corporation is an example of a first organization. The corporation eKYC provider is an example of a second organization. The corporation PKI unit 12 is an example of a first assignment unit and a verifying unit. The existence guarantee information of a corporation is an example of first information. The member existence guarantee information is an example of second information. The member information infrastructure unit 22 is an example of a second assignment unit. The extended ACME client unit 23 is an example of a transmission unit. The attribute information is an example of third information.

Although the embodiments of the present invention have been described in detail above, the present invention is not limited to such specific embodiments, and various modifications and changes can be made within the scope of the gist of the present invention described in the claims.

### REFERENCE SIGNS LIST

10 Existence guarantee device
11 Corporation eKYC unit
12 Corporation PKI unit
13 Existence guarantee authentication unit
20 Certificate application device
21 Member authentication infrastructure unit
22 Member information infrastructure unit
23 Extended ACME client unit
24 Existing ACME client unit
25 Secret key storage unit
30a Person-in-charge terminal
30b Senior terminal
40 CA server
41 Certificate issuing unit
100 Drive device
101 Recording medium
102 Auxiliary storage device
103 Memory device
104 CPU
105 Interface device
B Bus

1. A certificate issuing support system comprising: a certificate application device in a first organization making an application for issuing an EV certificate to a certificate authority; and an existence guarantee device included in a second organization that guarantees existence of the first organization,
wherein the existence guarantee device includes a memory; and a processor coupled to the memory and configured to:
assign a first electronic signature to first information guaranteeing existence of the first organization in response to a request from a terminal used by a member of the first organization, and
verify a second electronic signature assigned to second information that is generated by the certificate application device and guarantees affiliation of the member to the first organization in cooperation with the certificate authority, and
the certificate application device includes a memory; and a processor coupled to the memory and configured to:
assign a third electronic signature to third information indicating an authority of a person who approves the application for issuing the EV certificate, and
transmit the first information to which the first electronic signature is assigned, the second information to which the second electronic signature is assigned, and the third information to which the third electronic signature is assigned to the certificate authority in order to obtain an approval of the issuing of the EV certificate.

2. The certificate issuing support system according to claim 1,
wherein the processor of the existence guarantee device assigns the first electronic signature to the first information when the member is authenticated.

3. The certificate issuing support system according to claim 1,
wherein the certificate application device transmits the first information, the second information, and the third information to the certificate authority in addition to a procedure in accordance with an automatic certificate management environment (ACME).

4. A certificate issuing support method executed by a certificate application device in a first organization making an application for issuing an EV certificate to a certificate authority and an existence guarantee device included in a second organization that guarantees existence of the first organization,
wherein the existence guarantee device executes
assigning a first electronic signature to first information guaranteeing existence of the first organization in response to a request from a terminal used by a member of the first organization, and
verifying a second electronic signature assigned to second information that is generated by the certificate application device and guarantees affiliation of the member to the first organization in cooperation with the certificate authority, and
the certificate application device executes
assigning a third electronic signature to third information indicating an authority of a person who approves the application for issuing the EV certificate, and
transmitting the first information to which the first electronic signature is assigned, the second information to which the second electronic signature is assigned, and the third information to which the third electronic signature is assigned to the certificate authority in order to obtain an approval of the issuing of the EV certificate.

5. The certificate issuing support method according to claim 4,
wherein, in the assigning of the first electronic signature, the first electronic signature is assigned to the first information when the member is authenticated.

6. The certificate issuing support method according to claim 4,
wherein the certificate application device transmits the first information, the second information, and the third information to the certificate authority in addition to a procedure in accordance with an automatic certificate management environment (ACME).

7. A non-transitory computer-readable recording medium storing a program causing a computer to perform, by a certificate application device in a first organization making an application for issuing an EV certificate to a certificate authority,
assigning a third electronic signature to third information indicating an authority of a person who approves the application for issuing the EV certificate, and
transmitting first information to which a first electronic signature guaranteeing existence of the first organization is assigned, second information to which a second electronic signature that guarantees affiliation of a member to the first organization is assigned, and the third information to which the third electronic signature is assigned to the certificate authority in order to obtain an approval of the issuing of the EV certificate.
